(19) United States
(12) Patent Application Publication
(10) Pub. No.: US 2017/0115705 A1
(43) Pub. Date: Apr. 27, 2017

(54) COMPUTER APPARATUS

(71) Applicant: TPV-INVENTA Technology Co., Ltd., Taipei (TW)

(72) Inventors: Shih-Yu HSIEH, Taipei (TW); Cheng-Cheng LEE, Taipei (TW); Feng-Yu CHANG, Taipei (TW); Shih-Ti SUN, Taipei (TW)

(21) Appl. No.: 15/149,615

(22) Filed: May 9, 2016

(30) Foreign Application Priority Data
Oct. 23, 2015 (TW) 104134892

(51) Int. Cl. G06F 1/18

(52) U.S. Cl. CPC G06F 1/186; G06F 1/185

(57) ABSTRACT

A computer apparatus includes a first cover, a second cover, a motherboard, an expansion device and a detach assisting assembly. The second cover is detachably disposed on the first cove, and has an accommodation space and an opening. The motherboard is disposed between the first and second covers. The expansion device disposed in the accommodation space and connected to the motherboard is drawable from the accommodation space through the opening. The detach assisting assembly disposed in the accommodation space includes a slidable member and a rotatable member. The slidable member is slidable relative to the second cover for rotating the rotatable member to drive the first pressing part to press a side of the expansion device away from the opening, and thereby at least a part of the expansion device protrudes from the accommodation space through the opening.

### CROSS-REFERENCE TO RELATED APPLICATIONS

This non-provisional application claims priority under 35 U.S.C. §119(a) on Patent Application No(s). 104134892 filed in Taiwan R.O.C. on Oct. 23, 2015, the entire contents of which are hereby incorporated by reference.

### TECHNICAL FIELD

The present disclosure provides a computer apparatus, more particular to a computer apparatus having a detachable device.

### BACKGROUND

With the development of computer science and unitary system, the electronic devices, such as notebook computer, tablet and all-in-one personal computer (all-in-one PC, AIO) have designed to be lighter and smaller, which makes the electronic devices to be more popular in recent years.

### SUMMARY

According to the disclosure, a computer apparatus includes a first cover, a second cover, a motherboard, an expansion device and a detach assisting assembly. The second cover is detachably disposed on the first cover, and the second cover has an accommodation space and an opening connected to each other. The motherboard is disposed between the first cover and the second cover. The expansion device is disposed in the accommodation space and connected to the motherboard, and the expansion device is drawable from the accommodation space through the opening. The detach assisting assembly is disposed in the accommodation space. The detach assisting assembly includes a slidable member and a rotatable member. The slidable member is slidably located near the expansion device. The rotatable member includes a base part, a pivotal part and a first pressing part. The pivotal part and the first pressing part are connected to two sides of the base part, respectively. The base part is pivoted on the second cover. The pivotal part is pivoted on the slidable member. The slidable member is slidable relative to the second cover for rotating the rotatable member to drive the first pressing part to press a side of the expansion device away from the opening, and thereby at least a part of the expansion device protrudes from the accommodation space through the opening.

### BRIEF DESCRIPTION OF THE DRAWINGS

The present invention will become more understood from the detailed description given hereinbelow and the accompanying drawings which are given by way of illustration only and thus are not limitative of the present invention and wherein:

FIG. 1 is a partial perspective view of a computer apparatus according to an embodiment;

FIG. 2 is an exploded view of the computer apparatus as shown in FIG. 1;

FIG. 3 is a perspective view of a first fastening member as shown in FIG. 2;

FIG. 4 is a top view of the computer apparatus as shown in FIG. 1 with a part of a second cover being omitted;

FIG. 5 is a top view of the computer apparatus as shown in FIG. 4 with a tray being ejected;

FIG. 6 is a top view of the computer apparatus as shown in FIG. 4 with a rotatable member pressing the first fastening member;

FIG. 7 is a cross-sectional view along a line 7-7 of FIG. 6;

FIG. 8 is a top view of the computer apparatus as shown in FIG. 4 with the rotatable member pressing an expansion member; and

FIG. 9 is a cross-sectional view along a line a 9-9 of FIG. 8.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

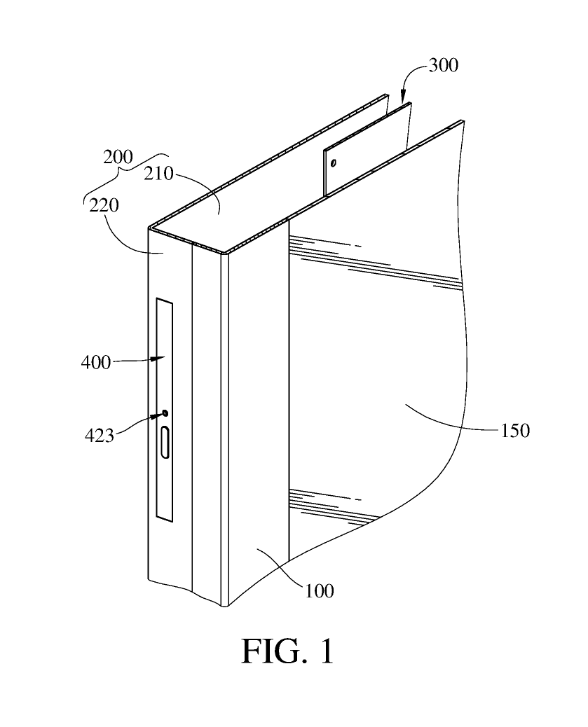

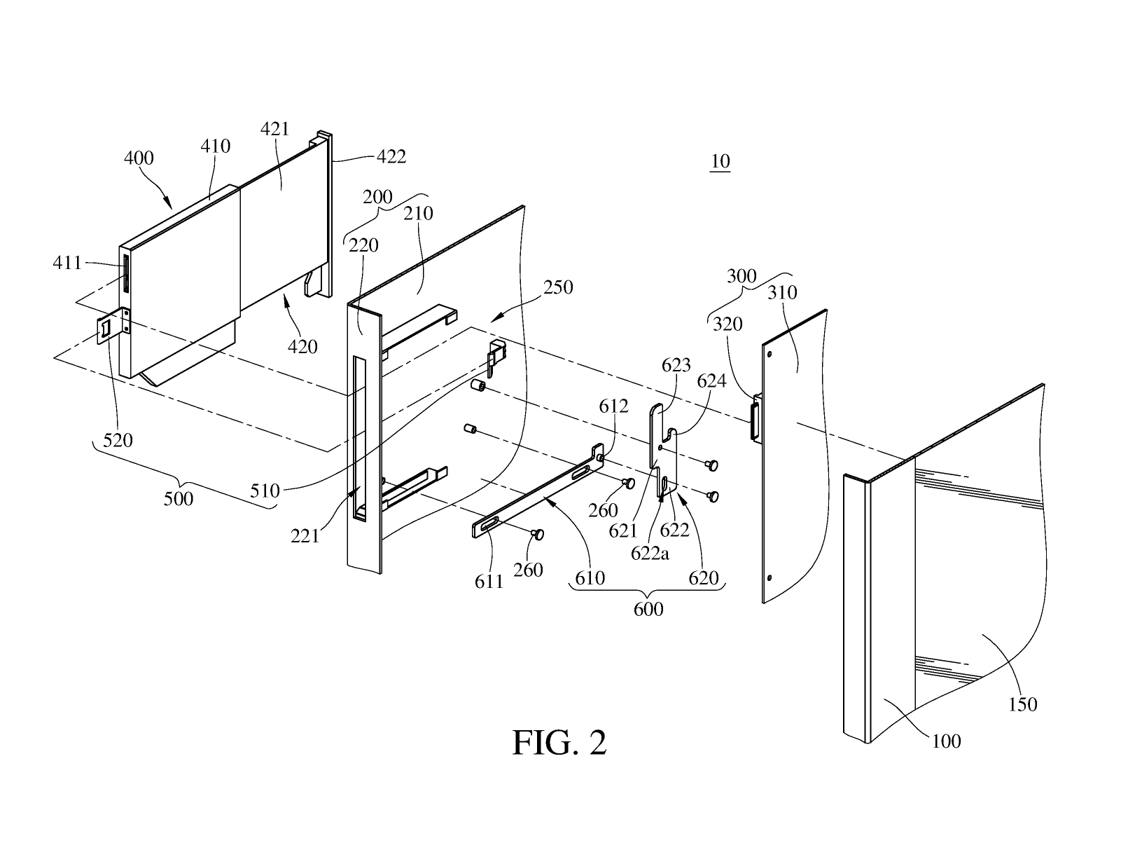

Please refer to FIG. 1 and FIG. 2. FIG. 1 is a partial perspective view of a computer apparatus according to an embodiment. FIG. 2 is an exploded view of the computer apparatus as shown in FIG. 1. In this embodiment, the computer apparatus 1 is an all-in-one PC, but the disclosure is not limited thereto. In other embodiments, the computer apparatus 1 can be a notebook computer or a tablet. The computer apparatus 10 includes a first cover 100, a second cover 200, a motherboard 300, an expansion device 400 and a detach assisting assembly 600.

The first cover 100, for example, can be a front cover of the all-in-one PC where a display 150 is disposed. The second cover 200, for example, can be a rear cover of the all-in-one PC. The second cover 200 is detachably disposed on the first cover 100. In detail, the second cover 200 includes a first plate 210 and a second plate 220. The second plate 220 is connected to and abutted against a side of the first plate 210. The second plate 220 has an opening 221 and an accommodation space 250 connected to each other.

The motherboard 300, for example, can include a central processing unit (CPU) and a computer memory. The motherboard 300 is disposed between the first cover 100 and the second cover 200. In this embodiment, the motherboard 300 is assembled to the first cover 100, but the disclosure is not limited thereto. In other embodiments, the motherboard 300 can be assembled to the second cover 200. Moreover, the motherboard 300 can include a circuit board 310 and a first port 320, and the first port 320 is disposed on the circuit board 310.

The expansion device 400, for example, can be an optical disk driver, a floppy disk or a card reader. The expansion device 400 is drawable from the accommodation space 250 through the opening 221, and the expansion device 400 can be inserted into the motherboard 300. In detail, take the expansion device 400 being the optical disk driver as an example, the expansion device 400 can include an expansion member 410 and a tray 420. The expansion member 410 can include a second port 411 for being detachably inserted into the first port 320 of the motherboard 300. The tray 420 is movably disposed on the expansion member 410 for covering and exposing the opening 221. In more detail, the tray 420 can include a supporting part 421 and a covering part 422. The supporting part 421, for example, is used for supporting a Compact disc (CD). The supporting part 421 is slidably disposed in the expansion member 410 of the expansion device 400. The covering part 422 is connected to a side of the supporting part 421 for covering the opening 221.

Furthermore, the covering part 422 can include an ejecting assembly 423 for ejecting the tray 420 from the expansion member 410. In detail, the ejecting assembly 423 can be a tray-loading mechanism of the optical disk driver which includes a hole and a driving assembly (not shown in the drawings). The hole extends through two sides of the covering part 422, and the driving assembly is for driving the tray 420 to move relative to the expansion member 410. When the expansion device 400 is unpowered, a needle can be inserted into the hole of the ejecting assembly 423 to trigger the driving assembly for ejecting the tray 420 from the expansion member 410 without electric power. Therefore, the covering part 422 exposes the opening 221 to the outside.

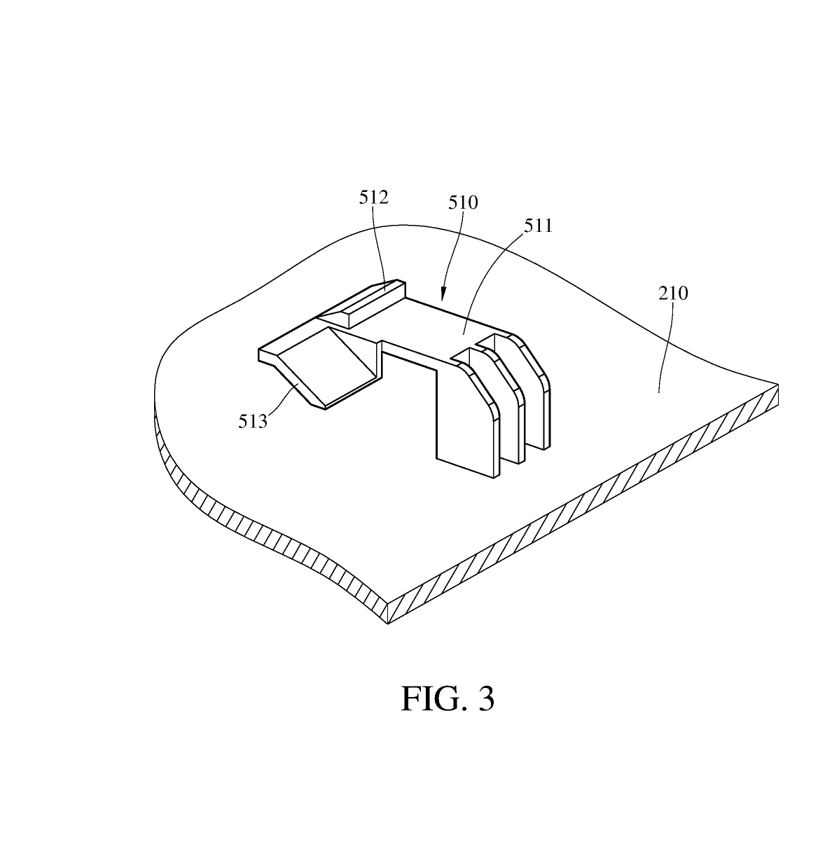

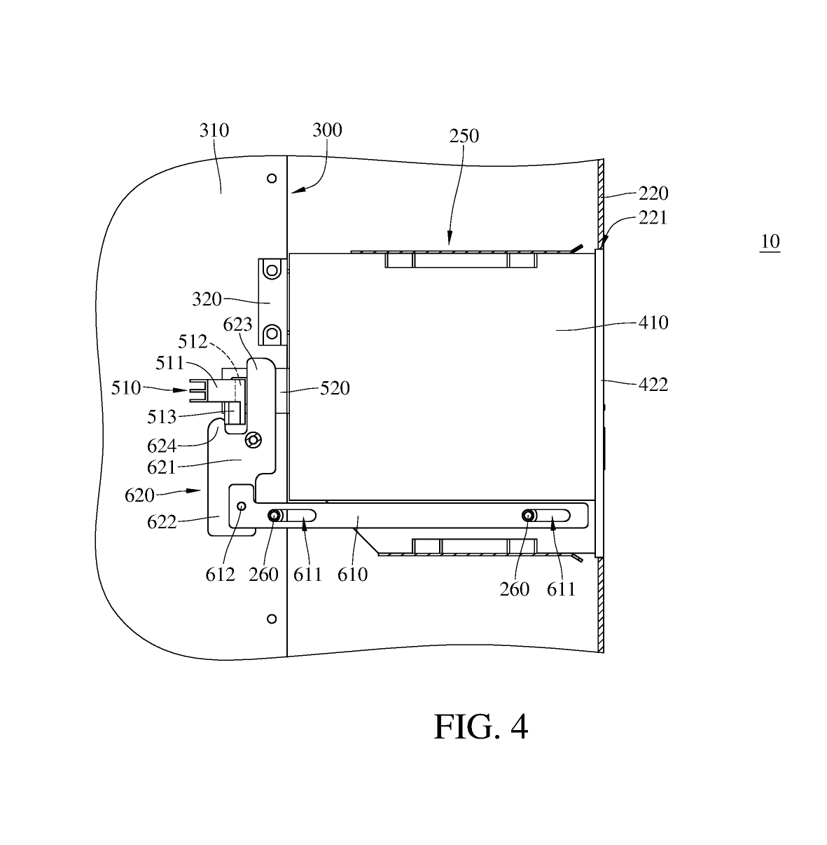

Please refer to FIG. 3 and FIG. 4. FIG. 3 is a perspective view of a first fastening member as shown in FIG. 2. FIG. 4 is a top view of the computer apparatus as shown in FIG. 1 with a part of a second cover being omitted. In order to improve the reliability of the assembly of the expansion device 400, the computer apparatus 10 can further include a fastening assembly 500.

The fastening assembly 500 can include a first fastening member 510 and a second fastening member 520. The first fastening member 510 can include an elastic part 511, a fastening part 512 and a pressed part 513. An end of the elastic part 511 is connected to the first plate 210 of the second cover. Both the fastening part 512 and the pressed part 513 are connected to another end of the elastic part 511. The second fastening member 520 is connected to the expansion member 410. When the expansion device 400 is disposed in the accommodation space 250 of the second cover 200, the second fastening member 520 is detachably fastened to the first fastening member 510. Therefore, the fastening assembly 500 is favorable for improving the reliability of the assembly of the expansion device 400. Moreover, the pressed part 513 has an inclined bottom surface. When an external force is applied on the inclined bottom surface of the pressed part 513, the pressed part 513 drives the fastening part 512 to together move toward the first plate 210.

As shown in FIG. 2 to FIG. 4, the detach assisting assembly 600 is disposed in the accommodation space 250, and the detach assisting assembly 600 includes a slidable member 610 and a rotatable member 620. The slidable member 610 is slidably located near the expansion device 400. In detail, the second cover 200 can have a plurality of guiding members 620, and the slidable member 610 can have a plurality of guiding slots 611. The guiding members 620 are slidably disposed on the guiding slots 611, respectively, so that the slidable member 610 is slidable relative to the expansion device 400.

The rotatable member 620 can include a base part 621, a pivotal part 622, a first pressing part 623 and a second pressing part 624. The pivotal part 622 and the first pressing part 623 are respectively connected to different two sides of the base part 621, and the pivotal part 622 and the first pressing part 623 respectively extends from the different two sides of the base part 621. In this embodiment, the two sides of the base part 621 are opposite to each other, and an extending direction of the pivotal part 622 and an extending direction of the pressing part 623 are opposite to each other. The second pressing part 624 protrudes from the base part 621. The base part 621 is pivoted on the first plate 210 of the second cover 200. The pivotal part 622 can include a sliding groove 622a, and the slidable member 610 can include a pivotal pin 612. The pivotal pin 612 is slidably disposed in the sliding groove 622a. When the slidable member 610 is slid relative to the second cover 200, the pivot pin 612 slides relative to the sliding groove 622a so as to rotate the rotatable member 620.

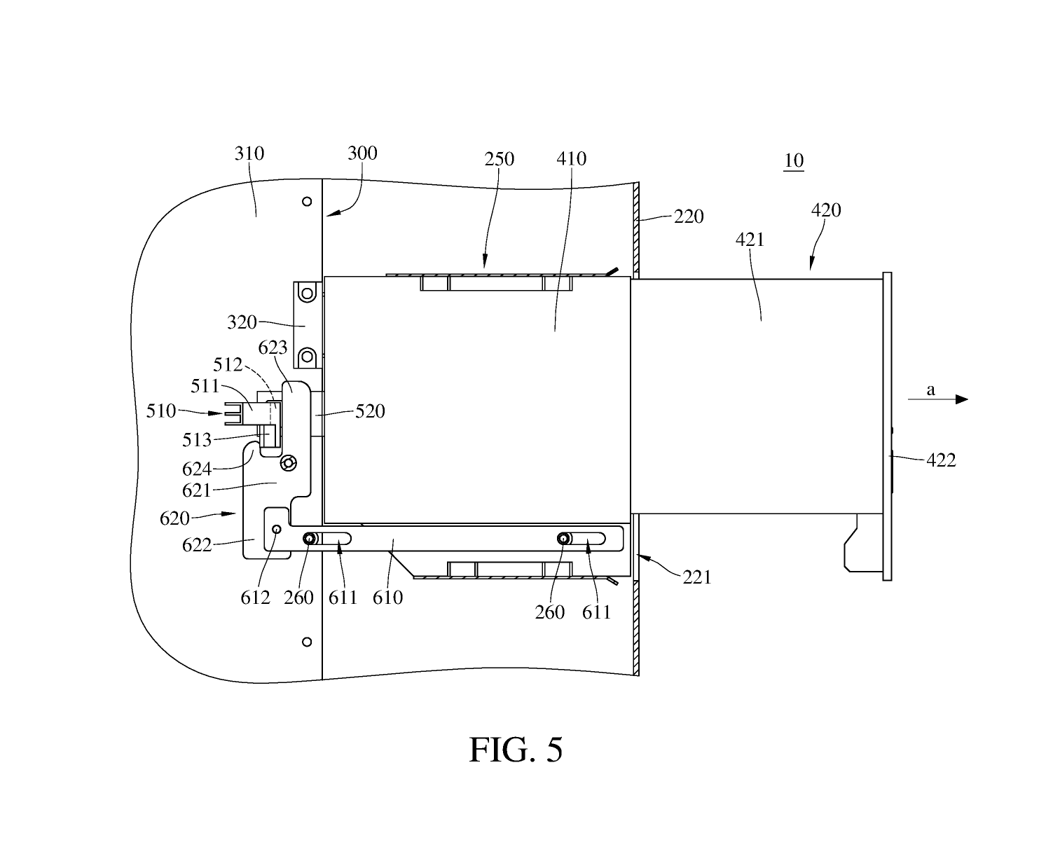

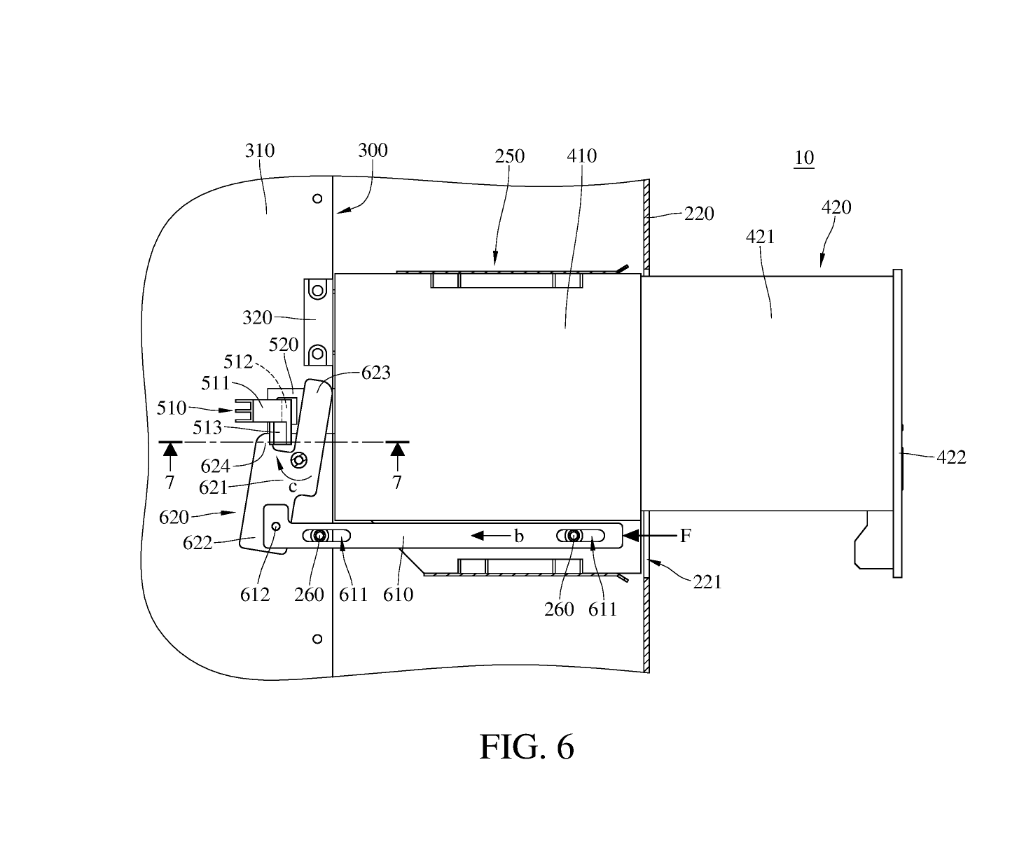

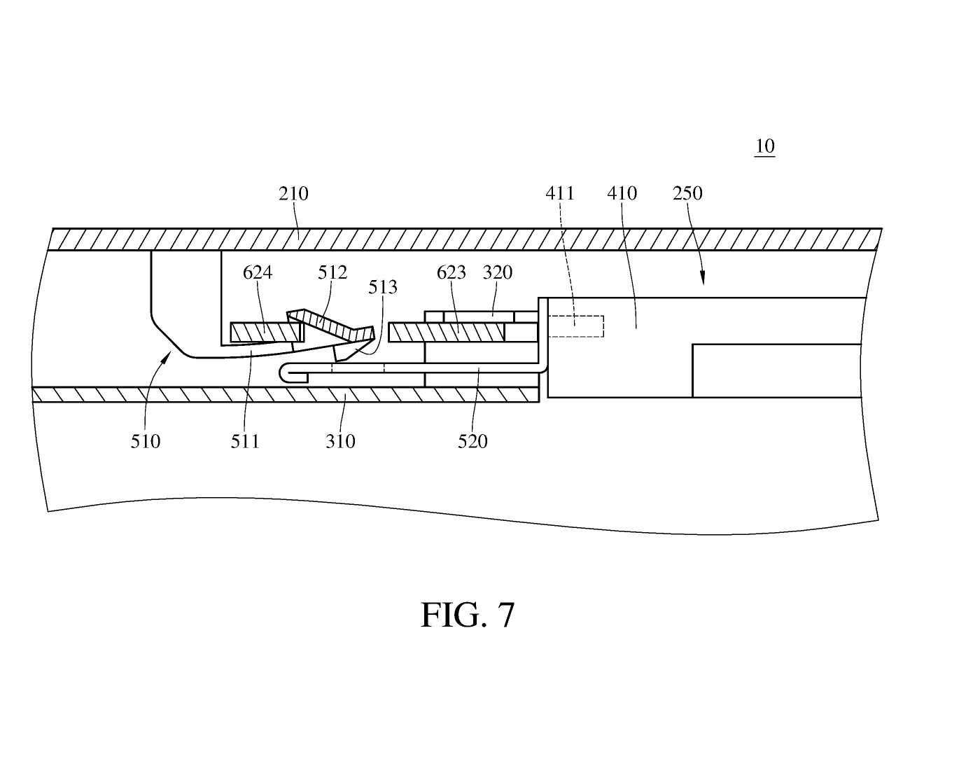

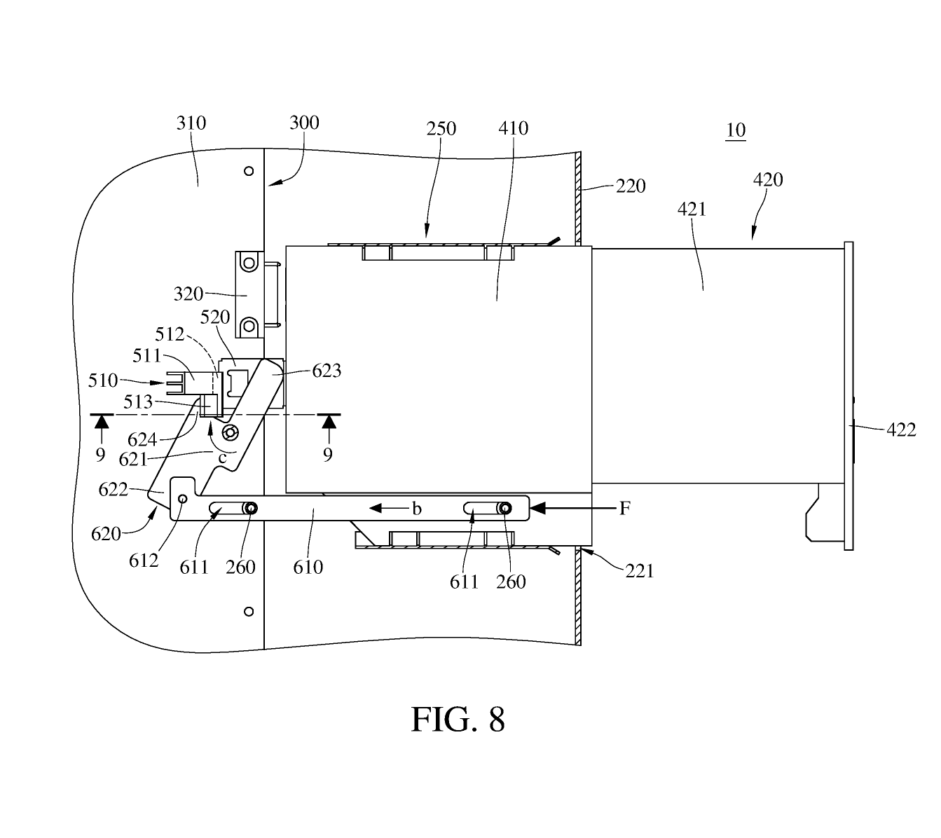

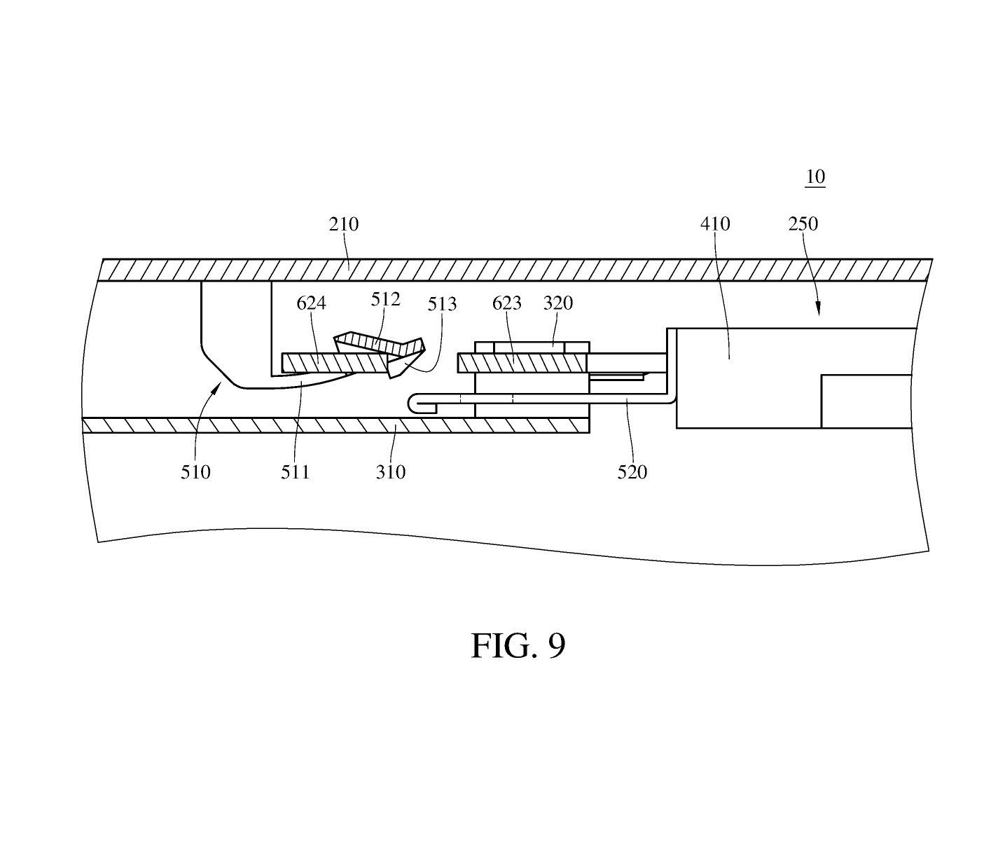

The following illustrates the operation of the computer apparatus 10. Please refer to FIG. 4 to FIG. 9. FIG. 5 is a top view of the computer apparatus as shown in FIG. 4 with a tray being ejected. FIG. 6 is a top view of the computer apparatus as shown in FIG. 4 with a rotatable member pressing the first fastening member. FIG. 7 is a cross-sectional view along a line 7-7 of FIG. 6. FIG. 8 is a top view of the computer apparatus as shown in FIG. 4 with the rotatable member pressing an expansion member. FIG. 9 is a cross-sectional view along a line a 9-9 of FIG. 8.

As shown in FIG. 4, the tray 420 of the expansion device 400 is located in the expansion member 410. As shown in FIG. 5, the ejecting assembly 423 is triggered so as to drive the tray 420 to eject along a direction a, and thereby the opening 221 is exposed to the outside. When the tray 420 exposes the opening 221, the slidable member 610 is exposed from the opening 221. That is, the slidable member 610 is inspectable and operable.

Next, as shown in FIG. 6, a force F is applied to the slidable member 610 so as to slide the slidable member 610 relative to the second cover 200 along a direction b, and thereby rotating the rotatable member 620 along a direction c. As shown in FIG. 6 and FIG. 7, when the rotatable member 620 is rotated, the second pressing part 624 of the rotatable member 620 presses the pressed part 513 of the first fastening member 510 so as to separate the fastening part 512 of the first fastening member 510 from the second fastening member 520. As shown in FIG. 8 and FIG. 9, the first pressing part 623 of the rotatable member 620 presses a side of the expansion device 400 away from the opening 221 so that a part of the the expansion member 410 protrudes from the accommodation space 250 through the opening 221, and the expansion device 400 can be drew from the accommodation space 250 via the opening 221. After the expansion device 400 is drew from the accommodation space 250, since there is no interference between the expansion device 400 and the second cover 200, it is favorable for easily detaching the second cover 200.

According to the disclosure, the detach assisting assembly exposed from the opening of the second cover is favorable for detaching the expansion device more easily. A user is able to slide the slidable member to rotate the rotatable member through the opening so as to drive the first pressing part to press a side of the expansion device away from the opening and thereby protruding at least a part of the expansion from the accommodation space through the opening. Therefore, the expansion device is able to be withdrawn from the without detaching the second cover. Furthermore, there is no interference between the expansion device and the second cover when the expansion device is withdrawn, so that the user can easily detach the second cover.

Moreover, before the first pressing part presses the expansion device, the second pressing part of the rotatable member presses the pressed part so as to detach the first fastening member from the second fastening member. Therefore, it is favorable for detaching the expansion device.

The foregoing description, for the purpose of explanation, has been described with reference to specific embodiments; however. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the disclosure to the precise forms disclosed. Modifications and variations are possible in view of the above teachings.

What is claimed is:

1. A computer apparatus, comprising:
a first cover;
a second cover detachably disposed on the first cover, and the second cover having an accommodation space and an opening connected to each other;
a motherboard disposed between the first cover and the second cover;
an expansion device disposed in the accommodation space and connected to the motherboard, and the expansion device being drawable from the accommodation space through the opening; and
a detach assisting assembly disposed in the accommodation space, the detach assisting assembly comprising a slidable member and a rotatable member, the slidable member being slidably located near the expansion device, the rotatable member comprising a base part, a pivotal part and a first pressing part, the pivotal part and the first pressing part connected to two sides of the base part, respectively, the base part pivoted on the second cover, the pivotal part pivoted on the slidable member, the slidable member being slidable relative to the second cover for rotating the rotatable member to drive the first pressing part to press a side of the expansion device away from the opening, and thereby at least a part of the expansion device protruding from the accommodation space through the opening.

2. The computer apparatus according to claim 1, wherein the motherboard comprises a circuit board and a first port, the first port is disposed on the circuit board, the expansion device comprises an expansion member and a tray, the expansion member comprises a second port detachably inserted into the first port of the motherboard, the tray is movably disposed on the expansion member for covering and exposing the opening, and the slidable member is exposed from the opening when the tray exposing the opening.

3. The computer apparatus according to claim 2, wherein the tray comprises a supporting part and a covering part, the supporting part is slidably disposed on the expansion member of the expansion device, and the covering is connected to a side of the supporting part for covering the opening.

4. The computer apparatus according to claim 3, wherein the covering part comprises an ejecting assembly, and the ejecting assembly is for ejecting the tray from the expansion member.

5. The computer apparatus according to claim 2, wherein the pivotal part and the first pressing part of the rotatable member respectively extends from the two sides of the base part, and an extending direction of the pivotal part and an extending direction of the pressing part are opposite to each other.

6. The computer apparatus according to claim 1, wherein the second cover comprises a plurality of guiding members, the slidable member comprises a plurality of guiding slots, and the plurality of guiding members are slidably disposed on the plurality of guiding slots, respectively.

7. The computer apparatus according to claim 1, wherein the second cover comprises a first plate and at least one second plate, the at least one second plate is connected to a side of the first plate, and the opening is located at the at least one second plate.

8. The computer apparatus according to claim 7, further comprising a fastening assembly comprising a first fastening member and a second fastening member, wherein the expansion device comprises an expansion member, the first fastening member is connected to the first plate of the second cover, the second fastening member is connected to the expansion member of the expansion device, and the first fastening member is detachably fastened to the second fastening member when the expansion device is located in the accommodation space.

9. The computer apparatus according to claim 8, wherein the first fastening member comprises an elastic part, a fastening part and a pressed part, the elastic part has two ends that are opposite to each other, one of the two ends of the elastic part is connected to the first plate, both the fastening part and the pressed part are connected to the other one of the two ends of the elastic part, the fastening part is detachably fastened to the second fastening member, the rotatable member further comprises a second pressing part connected to the base part, and the second pressing part is for pressing the pressed part so as to detach the fastening part of the first fastening member from the second fastening member.

10. The computer apparatus according to claim 1, wherein the pivotal part of the rotatable member comprising a sliding groove, the slidable member comprises a pivot pin slidably disposed on the sliding groove, when the slidable member is slid relative to the second cover, the pivot pin slides relative to the sliding groove so as to rotate the rotatable member.
